(19) United States
(12) Patent Application Publication
(10) Pub. No.: US 2002/0145535 A1
(43) Pub. Date: Oct. 10, 2002

(54) Vehicle control system for a vehicle data communications bus and having verification features

(76) Inventor: Kenneth E. Flick, Douglasville, GA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 10/043,077

(22) Filed: Jan. 9, 2002

Related U.S. Application Data
(60) Provisional application No. 60/260,519, filed on Jan. 9, 2001.

(51) Int. Cl. G08C 19/00

(52) U.S. Cl. 340/825.69; 340/825.72; 340/5.22; 307/10.6

(57) ABSTRACT

A vehicle control system include at least one uniquely coded transmitter to be carried by a user, a receiver at the vehicle for receiving signals from the at least one uniquely coded transmitter, and a controller at the vehicle and being connected to the receiver and the vehicle data communications bus. The controller is for communicating with the at least one vehicle device via the data communications bus, learning the at least one uniquely coded transmitter to permit control of a vehicle function by the user, and causing an indication of whether at least one new uniquely coded transmitter has been learned. In other embodiments, a biometric characteristic sensor is used in place of the receiver.

### RELATED APPLICATION

The present invention relates to U.S. provisional application serial No. 60/260,519 the entire contents of which are incorporated herein by reference.

### FIELD OF THE INVENTION

The present invention relates to the field of control systems, and more particularly, to a control system for a vehicle.

### BACKGROUND OF THE INVENTION

Vehicle security systems are widely used to deter vehicle theft, prevent theft of valuables from a vehicle, deter vandalism, and to protect vehicle owners and occupants. A typical automobile security system, for example, includes a central processor or controller connected to a plurality of vehicle sensors. The sensors, for example, may detect opening of the trunk, hood, doors, windows, and also movement of the vehicle or within the vehicle. Ultrasonic and microwave motion detectors, vibration sensors, sound discriminators, differential pressure sensors, and switches may be used as sensors. In addition, radar sensors may be used to monitor the area proximate the vehicle.

The controller typically operates to give an alarm indication in the event of triggering of a vehicle sensor. The alarm indication may typically be a flashing of the lights and/or the sounding of the vehicle horn or a siren. In addition, the vehicle fuel supply and/or ignition power may be selectively disabled based upon an alarm condition.

A typical security system also includes a receiver associated with the controller that cooperates with one or more remote transmitters typically carried by the user. The remote transmitter may be used to arm and disarm the vehicle security system or provide other remote control features from a predetermined range away from the vehicle. U.S. Pat. Nos. 5,654,688; 6,140,938 and 6,144,315, assigned to the assignee of the present invention, disclose a significant advance in vehicle security whereby the user may be provided with an indication of the number of remote transmitters learned and thereby capable of operating the system. The user may also be provided with an indication that the number of learned remote transmitters has recently changed. Accordingly, a would-be thief cannot simply learn a new transmitter, for example, to operate the vehicle's security system, and later return to steal of the vehicle or its contents.

Other vehicle security systems may be associated with the ignition of the vehicle. More particularly, one type of conventional vehicle security system includes a passive transponder either carried by the keychain or embedded in the ignition key. When the transponder is positioned adjacent the ignition switch, the transponder is inductively powered and transmits a uniquely coded signal to a receiver in the vehicle. When a properly coded transponder is detected, the vehicle engine may be allowed to start, for example. In other words, an ignition or fuel cutoff is normally operative to prevent the engine from starting or running, unless the proper transponder is sensed. Accordingly, vehicle security is increased.

The security system may have multiple transponders capable of disabling the ignition or fuel cutoff to thereby permit operation of the vehicle. These uniquely coded transponders may be added or deleted from the vehicle controller. Unfortunately, the owner of the vehicle may not know that a transponder has been added without authorization. Accordingly, to overcome this possible breach, U.S. Pat. No. 6,188,326, also assigned to the assignee of the present invention, discloses a system for providing the user a similar indication of the number of such coded or learned tokens, and/or providing an indication that the number has recently changed.

Along these lines, U.S. Pat. No. 6,140,939, assigned to the assignee of the present invention, discloses a similar system and methods for providing an indication of a change in the number and/or recently learned biometrics that are capable of causing operation of a remote-control system for a vehicle.

In response to the increased wiring complexity and costs, vehicle manufacturers have begun attempts to reduce the amount of wiring within vehicles to reduce weight, reduce wire routing problems, decrease costs, and reduce complications which may arise when troubleshooting the electrical system. For example, some manufacturers have adopted multiplexing schemes to reduce cables to three or four wires and to simplify the exchange of data among the various onboard electronic systems as disclosed, for example, in “The Thick and Thin of Car Cabling” by Thompson appearing in the IEEE Spectrum, Feb. 1996, pp. 42-45.

Implementing multiplexing concepts in vehicles in a cost-effective and reliable manner may not be easy. Successful implementation, for example, may require the development of low or error-free communications in what can be harsh vehicle environments. With multiplexing technology, the various electronic modules or devices may be linked by a single signal wire in a bus also containing a power wire, and one or more ground wires. Digital messages are communicated to all modules over the data communications bus. Each message may have one or more addresses associated with it so that the devices can recognize which messages to ignore and which messages to respond to or read.

Unfortunately, conventional vehicle control systems and even those sophisticated systems employing the verification features described above, such as aftermarket vehicle security systems, are typically for hardwired connection to vehicle devices and are not readily adaptable to a vehicle including a data communications bus. Other systems for the control of vehicle functions may also suffer from such shortcomings.

### SUMMARY OF THE INVENTION

In view of the foregoing background, it is therefore an object of the invention to provide a vehicle control system and related method for reducing the risk of an unauthorized remote transmitter, token, or biometric characteristic permitting an unauthorized person to be able to operate the vehicle control system, where the vehicle is of a type including a data communications bus.

This and other objects features and advantages in accordance with the present invention are provided by a vehicle control system including at least one uniquely coded transmitter to be carried by a user, a receiver at the vehicle for receiving signals from the at least one uniquely coded transmitter, and a controller at the vehicle and being connected to the receiver and the vehicle data communications bus. More particularly, the controller is for communicating with the at least one vehicle device via the data communications bus, learning the at least one uniquely coded transmitter to permit control of a vehicle function by the user, and causing an indication of whether at least one new uniquely coded transmitter has been learned.

In one particularly advantageous embodiment, the at least one vehicle device comprises a vehicle indicator, and the controller communicates with the vehicle indicator via the vehicle data communications bus to cause the indication of whether at least one new uniquely coded transmitter has been learned. For example, the vehicle indicator may comprise at least one of a light, a visual display, a vibration transducer, a speech message generator, and an audible signal generator. The vehicle may further comprise an instrument panel carrying the vehicle indicator. Accordingly, a security or other vehicle control system can be readily interfaced into a vehicle of a type including a data communications bus extending throughout the vehicle, and which provides important verification features.

The at least one vehicle device may be a vehicle sensor. In this variation, the controller may communicate with the vehicle sensor via the vehicle data communications bus, such as for performing a vehicle security function. Along these lines, the at least one vehicle device may comprise a vehicle alarm indicator, and the controller may communicate with the vehicle alarm indicator via the vehicle data communications bus, such as to sound a security alarm indication at the vehicle.

The at least one vehicle device may also comprise a controllable vehicle device, and in these embodiments, the controller may communicate with the controllable vehicle device via the vehicle data communications bus. For example, the controllable vehicle device may be associated with starting of a vehicle engine, such as for a vehicle security system and/or remote start system.

The controllable vehicle device may also be associated with vehicle door locks, such as the door lock motors. In these embodiments, the controller can provide a door locking and unlocking function, such as in response to the uniquely coded transmitter.

The controller may also be switchable to a learning mode to permit learning of the at least one uniquely coded transmitter. The controller may cause an indication that the learning mode has been entered. For example, the controller may cause an indication when the learning mode has last been entered, and/or cause an indication for progressively indicating a passage of time since the learning mode has last been entered. Accordingly, the user is made aware of a potentially unauthorized transmitter being learned that can operate the vehicle control system without the owner's permission.

The controller may cause an indication of a number of learned uniquely coded transmitters. The controller may alternately cause an indication of a change in a number of learned uniquely coded transmitters. Of course, in other embodiments, the controller may cause an indication of a change in a code of at least one learned uniquely coded transmitter. All of these techniques assure the authorized user that no one has surreptitiously learned a new transmitter to operate the controller.

The at least one uniquely coded transmitter may comprises at least one uniquely coded remote transmitter, such as typically used for security systems, remote start systems, and remote keyless entry systems. In other embodiments, the at least one uniquely coded transmitter may comprise at least one uniquely coded transponder transmitter. In other words the transponder transmitter may be selectively powered from proximity to a powering transmitter at the vehicle. Such uniquely coded transponder transmitters may of the type carried by the key, or associated keyring, for example.

Another aspect of the invention relates to a vehicle control method for a vehicle comprising a vehicle data communications bus and at least one vehicle device connected thereto. The method may comprise receiving signals from at least one uniquely coded transmitter at a receiver at the vehicle; and using a controller at the vehicle and connected to the receiver and the vehicle data communications bus. The controller may be used for communicating with the at least one vehicle device via the data communications bus, learning the at least one uniquely coded transmitter to permit control of a vehicle function by the user, and causing an indication of whether at least one new uniquely coded transmitter has been learned.

In a related class of embodiments, a biometric characteristic sensor is provided instead of the receiver for the uniquely coded transmitter. The biometric characteristic sensor is for sensing a unique biometric characteristic of a user. Accordingly, the controller may communicate with the at least one vehicle device via the data communications bus, learn the unique biometric characteristic to permit control of a vehicle function by the user, and cause an indication of whether at least one new unique biometric characteristic has been learned. The biometric sensor may comprise, for example, at least one of a fingerprint sensor, a voice pattern sensor, a facial pattern sensor, a skin pattern sensor, a hand pattern sensor, a venous pattern sensor and a retinal pattern sensor.

A related vehicle control method may include sensing a unique biometric characteristic of a user from a biometric characteristic sensor, and using a controller at the vehicle and connected to the biometric characteristic sensor and the vehicle data communications bus. The controller may be used for communicating with the at least one vehicle device via the data communications bus, learning the unique biometric characteristic to permit control of a vehicle function by the user, and causing an indication of whether at least one new unique biometric characteristic has been learned.

### BRIEF DESCRIPTION OF THE DRAWINGS

FIG. 1 is a schematic block diagram of a vehicle control system in accordance with a first embodiment of the invention.

FIG. 2 is a schematic block diagram of a vehicle control system in accordance with a second embodiment of the invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

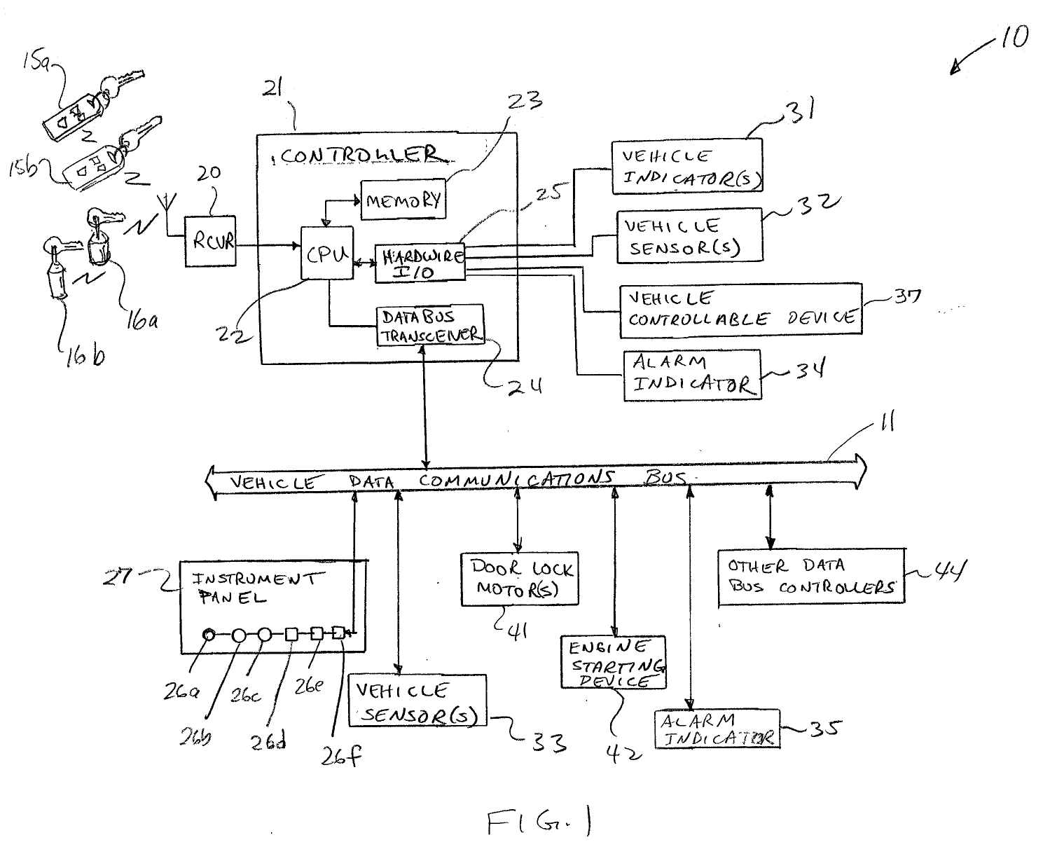

Referring initially to FIG. 1, the present invention is directed to a vehicle control system 10 which illustratively operates with a vehicle of a type including a vehicle data communications bus 11. The vehicle control system 11 provides increased security, such as for a number of uniquely coded transmitters as will be described in greater detail below. In addition, the system 10 is compatible with newer type vehicles including a data communications bus 11.

The control system 10 illustratively includes a plurality of uniquely coded transmitters, such as the remote transmitters 15a, 15b and/or the transponder transmitters 16a, 16b. Both types of transmitters may be carried by a user as will be appreciated by those skilled in the art. The remote transmitters 15a, 15b typically include a battery for providing electrical power to the transmitter circuitry contained within the common housing. In contrast, the transponder transmitters 16a, 16b are typically powered by a transponder powering transmitter, not shown, which is at the vehicle so that when the transponder transmitter is brought in proximity to the transponder powering transmitter, electrical energy will be captured and used to send a uniquely coded signal from the transponder transmitter circuitry. Either or both types of transmitters 15a, 16a may be used as will be appreciated by those skilled in the art. Other types of transmitters are also contemplated by the invention.

A receiver 20 is provided at the vehicle for receiving signals from the uniquely coded transmitters 15a, 16b and a controller 21 is provided at the vehicle. The controller 21 is illustratively connected to the receiver 20 and to the vehicle data communications bus. The controller 21 may include the schematically illustrated central processing unit 22 with a memory 23 connected thereto. In other embodiments, the memory 23 may be embedded within the CPU 22.

Communication to the vehicle data communications bus 11 is facilitated by the schematically illustrated data bus transceiver 24. As will be appreciated by those skilled in the art, the data bus transceiver 24 may include wireline transmitter and receiver circuitry for sending and receiving signals over the particularly vehicle data bus 11 used in the vehicle.

More particularly, the controller 21 is for communicating with at least one vehicle device via the data communications bus 11. The controller 21 is also for learning the at least one uniquely coded transmitter 15a-16b to permit control of a vehicle function by the user. In addition, the controller 21 is also for causing an indication of whether at least one new uniquely coded transmitter 15a-16b has been learned. As will be appreciated by those skilled in the art, the controller 21 may perform these function based upon coded instructions stored in the memory 23 for example, and carried out by the CPU 22 and its associated circuitry. The indication may be activated by turning of the vehicle ignition switch, closing of the vehicle door, periodically based on a predetermined schedule, or simply when the learning mode has recently been entered. Other equivalent approaches for generating the indication will also be appreciated by those skilled in the art.

In one particularly advantageous embodiment, the at least one vehicle device comprises a vehicle indicator, and the controller 21 communicates with the vehicle indicator via the vehicle data communications bus 11 to cause the indication of whether at least one new uniquely coded transmitter has been learned. As shown in the illustrated system 10, the indicator may comprise one or more icons or indicator lights 26a-26f on an instrument panel 27 of the vehicle. This embodiment is readily installed as an aftermarket device or may also be included as original equipment on the vehicle. As will be appreciated by those skilled in the art, the vehicle indicator in other embodiments may comprise at least one of a light, a visual display, a vibration transducer, a speech message generator, and an audible signal generator.

In other embodiments of the vehicle control system 11, the vehicle indicator 31 may of a type which connects to the controller 21 via a hardwire interface 25. In these embodiments, the controller 21 may perform other communications or functions via the vehicle data communications bus 11. In these embodiments, the vehicle indicator may also comprise at least one of a light, a visual display, a vibration transducer, a speech message generator, and an audible signal generator.

The at least one vehicle device may be a vehicle sensor, such as a vehicle sensor 32 connected to the controller 21 via the hardwire interface 25. Alternately, or in addition thereto, the at least one vehicle device may include a vehicle sensor 33 of a type that communicates with the controller 21 via the data communications bus 11 and the illustrated data bus transceiver 24. For example, the controller 21 may communicate with the vehicle sensor 33 via the vehicle data communications bus 11, such as for performing a vehicle security function. The sensors described above, for example, may include an ignition switch; a key in the ignition sensor; shock sensors; conventional trunk, hood, and door pin sensors or switches; a pre-warn sensor; brake sensor; and PRNDL sensor.

Along these lines, the at least one vehicle device may comprise a vehicle alarm indicator, such as the alarm indicator 34 which is hardwired to the controller 21 and/or the alarm indicator 35 connected to the controller via the vehicle data communications bus 11, such as to sound a security alarm indication at the vehicle.

As also shown in the illustrated control system 10, the at least one vehicle device may comprise a controllable vehicle device, either hardwired to the controller (as shown by the block labeled 37) and/or connected to the controller via the data communications bus. For example, two specific controllable devices in the form of door lock motors 41 and the engine starting device 42 are shown as the controllable devices connected to the controller 21 through the vehicle data communications bus 11. Control of the door lock motors 41 provides a remote keyless entry function. Control of the engine starting device 42 may provide a security-related engine immobilizer function, and/or may provide a convenience-related remote engine starting function as will be appreciated by those skilled in the art.

Of course, other similar controllable devices are also contemplated by the invention that can interface with the controller 21 through the hardwire interface 25 or data bus transceiver 24 as will be appreciated by those skilled in the art. In addition, the controller 21 may also communicate with one or more other controllers 44 either independently, or may communicate with such controllers to indirectly communicate with any other device connected to the vehicle data communications bus 11.

In the embodiments described herein, the controller 21 is able to learn a new uniquely coded transmitter 151-16b, and also communicates over the data communications bus 11. For example, in some embodiments, all communications may over the data communications bus 11 and no devices are connected to the optional hardwire interface 25. Of course, in other embodiments, it may still be desirable to hardwire certain vehicle devices to the controller 21.

The controller 21 may also be switchable to a learning mode to permit learning of the at least one uniquely coded transmitter 15a-16b. The controller 21 may also cause an indication that the learning mode has been entered. For instance, the controller 21 may cause an indication when the learning mode has last been entered, and/or cause an indication for progressively indicating a passage of time since the learning mode has last been entered. Accordingly, the user is made aware of a potentially unauthorized transmitter 15a-15b being learned that can operate the vehicle control system 10 without the owner's or authorized user's permission.

The controller 21 may cause an indication of a number of learned uniquely coded transmitters 15a-16b. The controller 21 may alternately cause an indication of a change in a number of learned uniquely coded transmitters 15a-16b. In still other embodiments, the controller 21 may cause an indication of a change in a code of at least one learned uniquely coded transmitter 15a-16b.

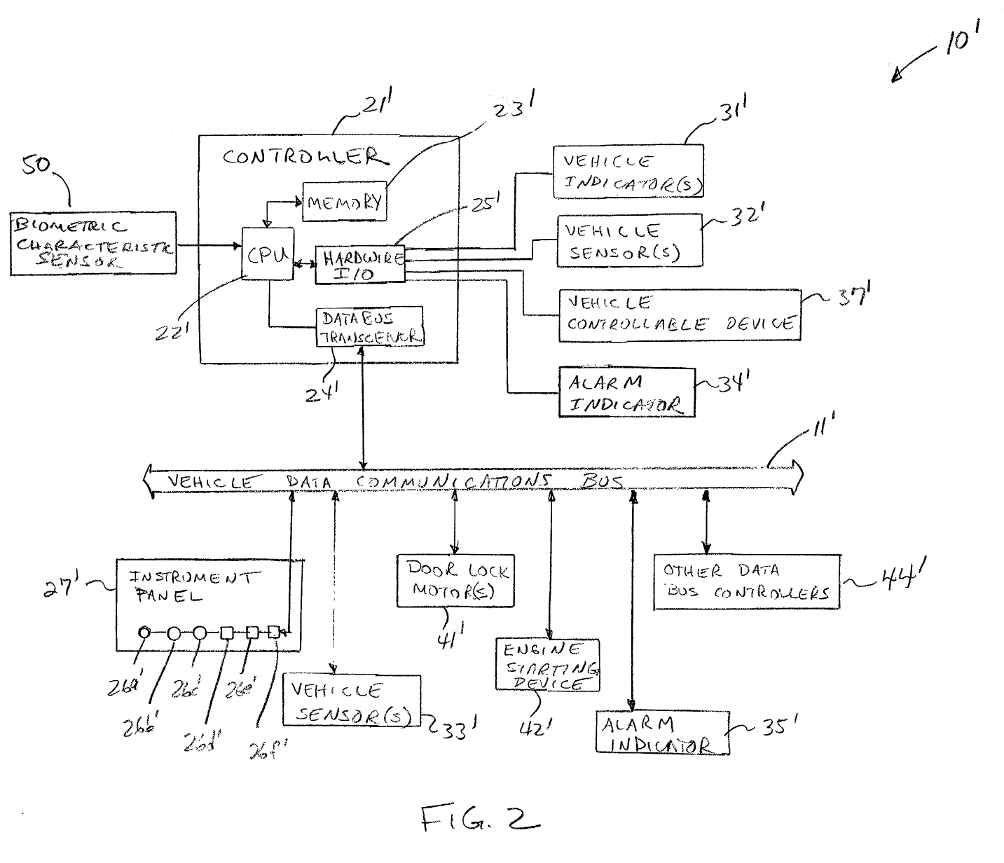

Turning now additionally to the vehicle control system 11′ as shown in FIG. 2, other concepts relating to verification are now described. In this embodiment of the system 11′, those elements already discussed above with respect to FIG. 1 are given prime notation and most require no further discussion herein. This embodiment differs in that the receiver 20 of the embodiment of FIG. 1 is now replaced in the embodiment of FIG. 2 by a biometric characteristic sensor or reader 50. The biometric characteristic sensor 50 is for sensing a unique biometric characteristic of a user. Accordingly, the controller 21′ may communicate with the at least one vehicle device via the data communications bus 11′, learn the unique biometric characteristic to permit control of a vehicle function by the user, and cause an indication of whether at least one new unique biometric characteristic has been learned.

As will be readily appreciated by those skilled in the art, the biometric sensor 50 may comprise, for example, at least one of a fingerprint sensor, a voice pattern sensor, a facial pattern sensor, a skin pattern sensor, a hand pattern sensor, a venous pattern sensor and a retinal pattern sensor.

Another aspect of the invention relates to a vehicle control method for a vehicle comprising a vehicle data communications bus and at least one vehicle device connected thereto as can be understood again with reference to FIG. 1. The method may comprise receiving signals from at least one uniquely coded transmitter 15a-16b at a receiver 20 at the vehicle, and using a controller 21 at the vehicle and connected to the receiver and the vehicle data communications bus 11. The controller 21 may be used for communicating with the at least one vehicle device via the data communications bus 11, learning the at least one uniquely coded transmitter 15a-16b to permit control of a vehicle function by the user, and causing an indication of whether at least one new uniquely coded transmitter has been learned.

Along these lines and referring again to FIG. 2, a related vehicle control method may include sensing a unique biometric characteristic of a user from a biometric characteristic sensor 50, and using a controller 21′ at the vehicle and connected to the biometric characteristic sensor and the vehicle data communications bus 11′. The controller 21′ may be used for communicating with the at least one vehicle device via the data communications bus 11′, learning the unique biometric characteristic to permit control of a vehicle function by the user, and causing an indication of whether at least one new unique biometric characteristic has been learned.

Other features and aspects relating to the verification feature may be found in U.S. Pat. Nos. 5,654,688; 6,140,938; 6,140,939; 6,144,315; 6,184,780 B1; 6,188,326 B1; and 6,320,514 B1, the entire disclosures of which are incorporated herein by reference. In addition, many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed.

That which is claimed is:

1. A vehicle control system for a vehicle comprising a vehicle data communications bus and at least one vehicle device connected thereto, the vehicle control system comprising:
at least one uniquely coded transmitter to be carried by a user;
a receiver at the vehicle for receiving signals from said at least one uniquely coded transmitter; and
a controller at the vehicle and connected to said receiver and the vehicle data communications bus for
communicating with the at least one vehicle device via the data communications bus,
learning the at least one uniquely coded transmitter to permit control of a vehicle function by the user, and
causing an indication of whether at least one new uniquely coded transmitter has been learned.

2. A vehicle control system according to claim 1 wherein the at least one vehicle device comprises a vehicle indicator; and wherein said controller communicates with the vehicle indicator via the vehicle data communications bus to cause the indication of whether at least one new uniquely coded transmitter has been learned.

3. A vehicle control system according to claim 2 wherein the vehicle indicator comprises at least one of a light, a visual display, a vibration transducer, a speech message generator, and an audible signal generator.

4. A vehicle control system according to claim 2 wherein the vehicle further comprises an instrument panel carrying the vehicle indicator.

5. A vehicle control system according to claim 1 wherein the at least one vehicle device comprises a vehicle sensor; and wherein said controller communicates with the vehicle sensor via the vehicle data communications bus.

6. A vehicle control system according to claim 1 wherein the at least one vehicle device comprises a vehicle alarm indicator; and wherein said controller communicates with the vehicle alarm indicator via the vehicle data communications bus.

7. A vehicle control system according to claim 1 wherein the at least one vehicle device comprises a controllable vehicle device; and wherein said controller communicates with the controllable vehicle device via the vehicle data communications bus.

8. A vehicle control system according to claim 7 wherein the controllable vehicle device is associated with starting of a vehicle engine.

9. A vehicle control system according to claim 7 wherein the controllable vehicle device is associated with vehicle door locks.

10. A vehicle control system according to claim 1 wherein said controller is switchable to a learning mode to permit learning of the at least one uniquely coded transmitter; and wherein said controller causes an indication that the learning mode has been entered.

11. A vehicle control system according to claim 10 wherein said controller causes an indication when the learning mode has last been entered.

12. A vehicle control system according to claim 10 wherein said controller causes an indication for progressively indicating a passage of time since the learning mode has last been entered.

13. A vehicle control system according to claim 1 wherein said controller causes an indication of a number of learned uniquely coded transmitters.

14. A vehicle control system according to claim 1 wherein said controller causes an indication of a change in a number of learned uniquely coded transmitters.

15. A vehicle control system according to claim 1 wherein said controller causes an indication of a change in a code of at least one learned uniquely coded transmitter.

16. A vehicle control system according to claim 1 wherein said at least one uniquely coded transmitter comprises at least one uniquely coded remote transmitter.

17. A vehicle control system according to claim 1 wherein said at least one uniquely coded transmitter comprises at least one uniquely coded transponder transmitter.

18. A vehicle control system for a vehicle comprising a vehicle data communications bus and a vehicle indicator connected thereto, the vehicle control system comprising:
at least one uniquely coded transmitter to be carried by a user;
a receiver at the vehicle for receiving signals from said at least one uniquely coded transmitter; and
a controller at the vehicle and connected to said receiver and the vehicle data communications bus for
learning the at least one uniquely coded transmitter to permit control of a vehicle function by the user, and
communicating with the vehicle indicator via said data communications bus to cause an indication of whether at least one new uniquely coded transmitter has been learned.

19. A vehicle control system according to claim 18 wherein the vehicle indicator comprises at least one of a light, a visual display, a vibration transducer, a speech message generator, and an audible signal generator.

20. A vehicle control system according to claim 18 wherein the vehicle further comprises an instrument panel carrying the vehicle indicator.

21. A vehicle control system according to claim 18 wherein the vehicle further comprises a vehicle sensor; and wherein said controller communicates with the vehicle sensor via the vehicle data communications bus.

22. A vehicle control system according to claim 18 wherein the vehicle further comprises a vehicle alarm indicator; and wherein said controller communicates with the vehicle alarm indicator via the vehicle data communications bus.

23. A vehicle control system according to claim 18 wherein the vehicle further comprises a controllable vehicle device; and wherein said controller communicates with the controllable vehicle device via the vehicle data communications bus.

24. A vehicle control system according to claim 18 wherein said controller is switchable to a learning mode to permit learning of the at least one uniquely coded transmitter; and wherein said controller causes an indication that the learning mode has been entered.

25. A vehicle control system according to claim 24 wherein said controller causes an indication when the learning mode has last been entered.

26. A vehicle control system according to claim 24 wherein said controller causes an indication for progressively indicating a passage of time since the learning mode has last been entered.

27. A vehicle control system according to claim 18 wherein said controller causes an indication of a number of learned uniquely coded transmitters.

28. A vehicle control system according to claim 18 wherein said controller causes an indication of a change in a number of learned uniquely coded transmitters.

29. A vehicle control system according to claim 18 wherein said controller causes an indication of a change in a code of at least one learned uniquely coded transmitter.

30. A vehicle control system for a vehicle comprising a vehicle data communications bus and at least one vehicle device connected thereto, the vehicle control system comprising:
a biometric characteristic sensor for sensing a unique biometric characteristic of a user; and
a controller at the vehicle and connected to said biometric characteristic sensor and the vehicle data communications bus for
communicating with the at least one vehicle device via the data communications bus,
learning the unique biometric characteristic to permit control of a vehicle function by the user, and
causing an indication of whether at least one new unique biometric characteristic has been learned.

31. A vehicle control system according to claim 30 wherein the at least one vehicle device comprises a vehicle indicator; and wherein said controller communicates with the vehicle indicator via the vehicle data communications bus to cause the indication of whether at least one new unique biometric characteristic has been learned.

32. A vehicle control system according to claim 31 wherein the vehicle indicator comprises at least one of a light, a visual display, a vibration transducer, a speech message generator, and an audible signal generator.

33. A vehicle control system according to claim 31 wherein the vehicle comprises an instrument panel carrying the vehicle indicator.

34. A vehicle control system according to claim 30 wherein the at least one vehicle device comprises a vehicle sensor; and wherein said controller communicates with the vehicle sensor via the vehicle data communications bus.

35. A vehicle control system according to claim 30 wherein the at least one vehicle device comprises a vehicle alarm indicator; and wherein said controller communicates with the vehicle alarm indicator via the vehicle data communications bus.

36. A vehicle control system according to claim 30 wherein the at least one vehicle device comprises a controllable vehicle device; and wherein said controller communicates with the controllable vehicle device via the vehicle data communications bus.

37. A vehicle control system according to claim 36 wherein the controllable vehicle device is associated with starting of a vehicle engine.

38. A vehicle control system according to claim 36 wherein the controllable vehicle device is associated with vehicle door locks.

39. A vehicle control system according to claim 30 wherein said controller is switchable to a learning mode to permit learning of the at least one uniquely coded transmitter; and wherein said controller causes an indication that the learning mode has been entered.

40. A vehicle control system according to claim 39 wherein said controller causes an indication when the learning mode has last been entered.

41. A vehicle control system according to claim 39 wherein said controller causes an indication for progressively indicating a passage of time since the learning mode has last been entered.

42. A vehicle control system according to claim 30 wherein said controller causes an indication of a number of learned uniquely coded transmitters.

43. A vehicle control system according to claim 30 wherein said controller causes an indication of a change in a number of learned uniquely coded transmitters.

44. A vehicle control system according to claim 30 wherein said controller causes an indication of a change in a code of at least one learned uniquely coded transmitter.

45. A vehicle control system according to claim 30 wherein said biometric sensor comprises at least one of a fingerprint sensor, a voice pattern sensor, a facial pattern sensor, a skin pattern sensor, a hand pattern sensor, a venous pattern sensor and a retinal pattern sensor.

46. A vehicle control method for a vehicle comprising a vehicle data communications bus and at least one vehicle device connected thereto, the method comprising:
receiving signals from at least one uniquely coded transmitter at a receiver at the vehicle; and
using a controller at the vehicle and connected to the receiver and the vehicle data communications bus for
communicating with the at least one vehicle device via the data communications bus,
learning the at least one uniquely coded transmitter to permit control of a vehicle function by the user, and
causing an indication of whether at least one new uniquely coded transmitter has been learned.

47. A method according to claim 46 wherein the at least one vehicle device comprises a vehicle indicator; and wherein said controller communicates with the vehicle indicator via the vehicle data communications bus to cause the indication of whether at least one new uniquely coded transmitter has been learned.

48. A method according to claim 47 wherein the vehicle indicator comprises at least one of a light, a visual display, a vibration transducer, a speech message generator, and an audible signal generator.

49. A method according to claim 47 wherein the vehicle further comprises an instrument panel carrying the vehicle indicator.

50. A method according to claim 46 wherein the at least one vehicle device comprises a vehicle sensor; and wherein said controller communicates with the vehicle sensor via the vehicle data communications bus.

51. A method according to claim 46 wherein the at least one vehicle device comprises a vehicle alarm indicator; and wherein said controller communicates with the vehicle alarm indicator via the vehicle data communications bus.

52. A method according to claim 46 wherein the at least one vehicle device comprises a controllable vehicle device; and wherein said controller communicates with the controllable vehicle device via the vehicle data communications bus.

53. A method according to claim 46 wherein said controller is switchable to a learning mode to permit learning of the at least one uniquely coded transmitter; and wherein said controller causes an indication that the learning mode has been entered.

54. A method according to claim 46 wherein said controller causes an indication of a number of learned uniquely coded transmitters.

55. A method according to claim 46 wherein said controller causes an indication of a change in a number of learned uniquely coded transmitters.

56. A method according to claim 46 wherein said controller causes an indication of a change in a code of at least one learned uniquely coded transmitter.

57. A vehicle control method for a vehicle comprising a vehicle data communications bus and at least one vehicle device connected thereto, the method comprising:
sensing a unique biometric characteristic of a user from a biometric characteristic sensor; and
using a controller at the vehicle and connected to said biometric characteristic sensor and the vehicle data communications bus for
communicating with the at least one vehicle device via the data communications bus,
learning the unique biometric characteristic to permit control of a vehicle function by the user, and
causing an indication of whether at least one new unique biometric characteristic has been learned.

58. A method according to claim 57 wherein the at least one vehicle device comprises a vehicle indicator; and wherein said controller communicates with the vehicle indicator via the vehicle data communications bus to cause the indication of whether at least one new uniquely coded transmitter has been learned.

59. A method according to claim 58 wherein the vehicle indicator comprises at least one of a light, a visual display, a vibration transducer, a speech message generator, and an audible signal generator.

60. A method according to claim 58 wherein the vehicle further comprises an instrument panel carrying the vehicle indicator.

61. A method according to claim 57 wherein the at least one vehicle device comprises a vehicle sensor; and wherein said controller communicates with the vehicle sensor via the vehicle data communications bus.

62. A method according to claim 57 wherein the at least one vehicle device comprises a vehicle alarm indicator; and wherein said controller communicates with the vehicle alarm indicator via the vehicle data communications bus.

63. A method according to claim 57 wherein the at least one vehicle device comprises a controllable vehicle device; and wherein said controller communicates with the controllable vehicle device via the vehicle data communications bus.

64. A method according to claim 57 wherein said controller is switchable to a learning mode to permit learning of the at least one uniquely coded transmitter; and wherein said controller causes an indication that the learning mode has been entered.

65. A method according to claim 57 wherein said controller causes an indication of a number of learned uniquely coded transmitters.

66. A method according to claim 57 wherein said controller causes an indication of a change in a number of learned uniquely coded transmitters.

67. A method according to claim 57 wherein said controller causes an indication of a change in a code of at least one learned uniquely coded transmitter.
